(19) United States
(12) Patent Application Publication
(10) Pub. No.: US 2020/0232428 A1
(43) Pub. Date: Jul. 23, 2020

(54) Controlling One or More Intake Manifold Tuning Valves (IMTV) In An Internal Combustion Engine

(71) Applicant: GM Global Technology Operations LLC, Detroit, MI (US)

(72) Inventors: Mark R. Claywell, Birmingham, MI (US); Maqsood Rizwan Ali Khan, Rochester Hills, MI (US); Jacob C. Hedrick, Orion, MI (US)

(21) Appl. No.: 16/254,119

(22) Filed: Jan. 22, 2019

(51) Int. Cl. F02M 35/10; F02D 41/00

(52) U.S. Cl. CPC F02M 35/10255; F02D 41/0002; F02D 2200/101; F02D 2200/0414; F02M 35/10144

(57) ABSTRACT

An internal combustion engine has a variable intake manifold with one or more intake manifold tuning valves. Controlling the intake manifold tuning valve(s) involves determining an operating mode switching point of the intake manifold tuning valve(s). The operating mode switching point initiates opening and closing movements of the intake manifold tuning valve(s). The operating mode switching point is determined based in part or more upon temperature of intake air in the variable intake manifold.

The present disclosure relates to internal combustion engines, and more particularly relates to control of intake manifold tuning valves (IMTVs) equipped in internal combustion engines.

An internal combustion engine of an automobile typically has an intake manifold that distributes air to cylinders of the engine. In general, an intake manifold is made up of a plenum area and runners spanning from the plenum area and to the engine's cylinders. A variable intake manifold is a type of manifold intended to enhance the volumetric efficiency among ranges of engine speeds amid engine operation. This is accomplished, according to one design, with separate plenum areas and one or more intake manifold tuning valves (IMTVs) installed between the areas. When the IMTV(s) is opened, the separate plenum areas open to each other and establish a larger plenum area for distributed air. The opening and closing movements of the IMTV(s) are conventionally managed according to predefined engine speed setpoints.

### SUMMARY

In an embodiment, a method of controlling one or more intake manifold tuning valves in an internal combustion engine may involve determining an operating mode switching point of the intake manifold tuning valve(s) based in part or more upon temperature of intake air in the intake manifold.

In an embodiment, the operating mode switching point of the intake manifold tuning valve(s) shifts to varying engine speeds at varying intake air temperatures.

In an embodiment, the intake manifold tuning valve(s) has a first operating mode switching point during a range of higher engine speeds at a first intake air temperature. And the intake manifold tuning valve(s) has a second operating mode switching point during the range of higher engine speeds at a second intake air temperature.

In an embodiment, the first operating mode switching point is initiated at a first engine speed of the range of higher engine speeds. And the second operating mode switching point is initiated at a second engine speed of the range of higher engine speeds.

In an embodiment, determining the operating mode switching point of the intake manifold tuning valve(s) involves the use of an intake air correction factor.

In an embodiment, determining the operating mode switching point of the intake manifold tuning valve(s) involves the use of an intake air temperature lookup table.

In an embodiment, an internal combustion engine employs the method of controlling the intake manifold tuning valve.

In an embodiment, an internal combustion engine may include a variable intake manifold. The variable intake manifold may have one or more intake manifold tuning valves that reside within a plenum of the variable intake manifold. The intake manifold tuning valve(s) is controlled by a controller. The intake manifold tuning valve(s) has a predetermined operating mode switching point. The predetermined operating mode switching point shifts to varying speeds of the internal combustion engine according to temperature of air in the variable intake manifold.

In an embodiment, the intake manifold tuning valve(s) has a first predetermined operating mode switching point during a range of higher engine speeds at a first temperature of air in the variable intake manifold. And the intake manifold tuning valve(s) has a second predetermined operating mode switching point during the range of higher engine speeds at a second temperature of air in the variable intake manifold.

In an embodiment, the first predetermined operating mode switching point is initiated at a first engine speed of the range of higher engine speeds. And the second predetermined operating mode switching point is initiated at a second engine speed of the range of higher engine speeds.

In an embodiment, control of the intake manifold tuning valve(s) by way of the controller at the predetermined operating mode switching point involves the use of an intake air correction factor.

In an embodiment, control of the intake manifold tuning valve(s) by way of the controller at the predetermined operating mode switching point involves the use of a lookup table.

In an embodiment, a method of controlling one or more intake manifold tuning valves in an internal combustion engine involves initiating opening and closing movements of the intake manifold tuning valve(s) according to temperature of intake air in the intake manifold. The initiated opening and closing movements of the intake manifold tuning valve(s) shifts to varying engine speeds at varying intake air temperatures.

In an embodiment, the initiated opening and closing movements of the intake manifold tuning valve(s) are per a predetermined operating mode switching point that shifts to varying engine speeds according to temperature of intake air in the intake manifold.

In an embodiment, the opening and closing movements of the intake manifold tuning valve(s) are initiated during a range of higher engine speeds at a first temperature of intake air in the intake manifold. And the opening and closing movements of the intake manifold tuning valve(s) are initiated during the range of higher engine speeds at a second temperature of intake air in the intake manifold.

In an embodiment, initiating opening and closing movements of the intake manifold tuning valve(s) according to temperature of intake air in the intake manifold involves the use of an intake air correction factor.

In an embodiment, initiating opening and closing movements of the intake manifold tuning valve(s) according to temperature of intake air in the intake manifold involves the use of an intake air temperature lookup table.

In an embodiment, an internal combustion engine employs the method of controlling the intake manifold tuning valve.

### BRIEF DESCRIPTION OF THE DRAWINGS

One or more aspects of the disclosure will hereinafter be described in conjunction with the appended drawings, wherein like designations denote like elements, and wherein:

FIG. 1 is a schematic depiction of an embodiment of an internal combustion engine;

FIG. 2 is a schematic depiction of another embodiment of an internal combustion engine;

FIG. 3 is a graph presenting loss of brake torque at differing intake air temperatures for an intake manifold tuning valve that is controlled by a method that does not account for intake air temperature, with engine speed in revolutions per minute (RPM) plotted on an x-axis and with brake torque loss from a reference tuning condition at an intake air temperature of 10° C. in percent (%) plotted on a y-axis;

FIG. 4 is a graph presenting actual closings of intake manifold tuning valves versus theoretical closings based on the speeds of sound, with engine speed in RPM plotted on an x-axis and with ambient temperature of intake air in degrees Celsius (° C.) plotted on a y-axis; and

FIGS. 5A-5E are graphs presenting optimal calibrations of intake manifold tuning valves at differing intake air temperatures, with engine speed in RPM plotted on an x-axis and with angle of intake manifold tuning valve in degrees) (°) plotted on a y-axis.

### DETAILED DESCRIPTION

With reference to the figures, an internal combustion engine 10 has a variable intake manifold 12 with one or more intake manifold tuning valves (IMTV) 14. Unlike past efforts, a method of controlling the IMTV(s) 14 introduces temperature of intake air as a factor for its control scheme. Predetermined operating mode switching points —i.e., opening and closing movement initiations—of the IMTV(s) 14 are shifted to different speeds of the internal combustion engine 10 at different temperatures of air in the variable intake manifold 12. In the past, the opening and closing movements of intake manifold tuning valves were set according to engine speed per the particular performance characteristics of the accompanying engines, and did not account for temperature of intake air. Accounting for temperature of intake air in the determination of operating mode switching points, as detailed in this description and unlike previous efforts, has shown to minimize brake torque losses, improve volumetric efficiency of the internal combustion engine 10, and ultimately enhance and optimize the overall calibration and performance of the internal combustion engine 10 amid a wide range of ambient operating conditions. The internal combustion engine 10 and its control method are described below in the context of an automotive application, yet could be equipped in non-automotive applications as well.

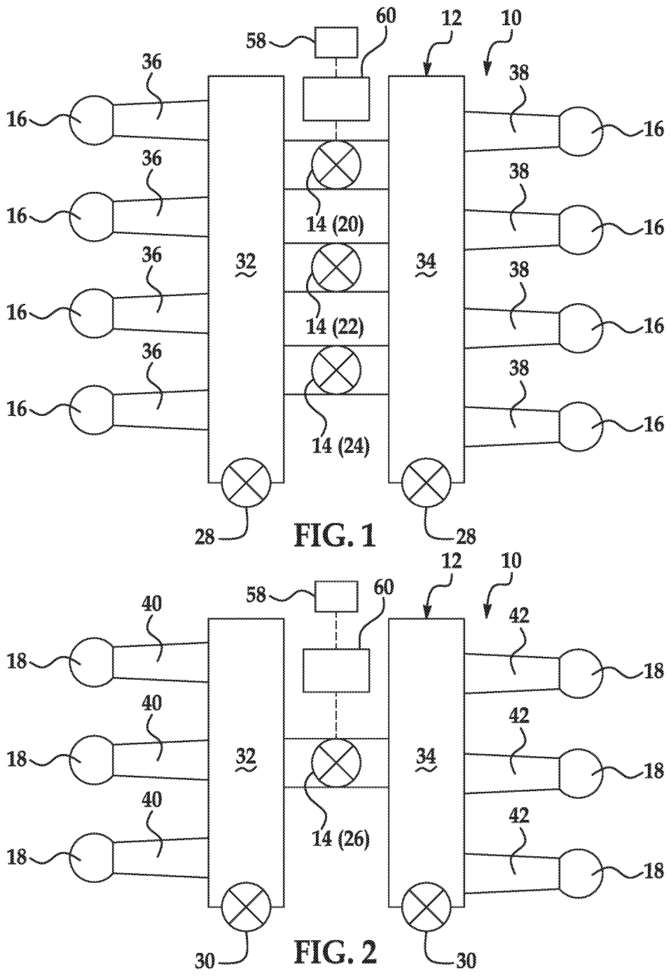

The method of controlling the IMTV(s) 14 can be implemented in internal combustion engines of various designs and constructions. As but two examples, the internal combustion engine 10 of FIG. 1 is a V8 type, and the internal combustion engine 10 of FIG. 2 is a V6 type. The V8 internal combustion engine 10 has a total of eight combustion cylinders 16, and the V6 internal combustion engine 10 has a total of six combustion cylinders 18. Further, the V8 internal combustion engine 10 of FIG. 1 has three intake manifold tuning valves: a first intake manifold tuning valve 20, a second intake manifold tuning valve 22, and a third intake manifold tuning valve 24. In an example with multiple IMTVs such as this one, some or all of the IMTVs can be ganged together and can exhibit concurrent opening and closing movement initiations. The V6 internal combustion engine 10 of FIG. 2, on the other hand, has a single intake manifold tuning valve 26. Again, the method of controlling the IMTV(s) 14 as described herein can be implemented on other internal combustion engines apart from those of the figures, including internal combustion engines of various cylinder quantities and arrangements and having various intake manifold tuning valve quantities and arrangements.

In FIG. 1, the internal combustion engine 10 has a pair of throttle bodies 28 for introducing air into the variable intake manifold 12 and for precluding air from entering the variable intake manifold 12. Similarly, the internal combustion engine 10 of FIG. 2 has a pair of throttle bodies 30 for carrying out the same functionality. The variable intake manifolds 12 of both FIGS. 1 and 2 has a first plenum area 32 and a second plenum area 34. In FIG. 1, the first and second plenum areas 32, 34 are set apart by the first and second and third intake manifold tuning valves 20, 22, 24. And in FIG. 2, the first and second plenum areas 32, 34 are set apart by the intake manifold tuning valve 26. Further, in FIG. 1, runners 36 span from the first plenum area 32 to the combustion cylinders 16, and runners 38 span from the second plenum area 34 to the combustion cylinders 16. And in FIG. 2, runners 40 span from the first plenum area 32 to the combustion cylinders 18, and runners 42 span from the second plenum area 34 to the combustion cylinders 18.

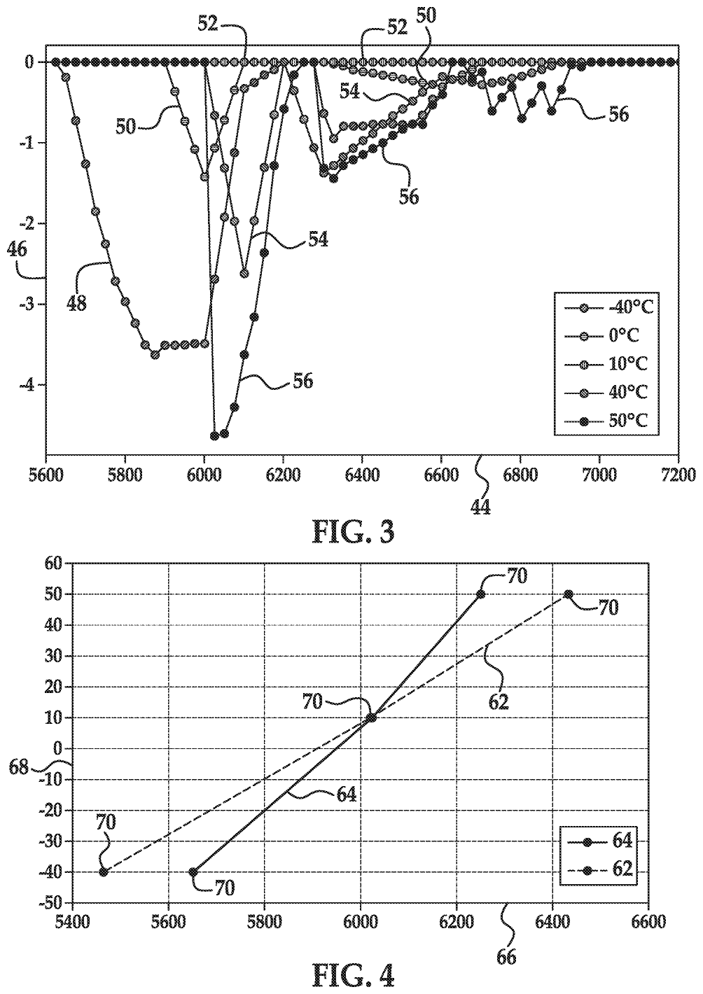

In the past, the opening and closing movements of intake manifold tuning valves were defined and set according to engine speed per the particular performance characteristics of the associated engines and absent any consideration of the temperature of air in the engines' intake manifolds. While these past efforts might be deemed suitable in certain applications, it has been found that brake torque losses can occur when opening and closing movements of IMTVs are calibrated and set without factoring the temperature of intake air in the established control scheme. Causes of temperature change of intake air, it has been found, can include ambient weather conditions, heat emanating from the intake manifold, a dedicated heater for this purpose, and/or other sources. FIG. 3 presents an example demonstration of past brake torque losses. In FIG. 3, engine speed in revolutions per minute (RPM) is plotted on an x-axis 44, and brake torque loss in percent (%) is plotted on a y-axis 46. The brake torque loss is with respect to a tuning of intake manifold tuning valves carried out at an intake air temperature of ten degrees Celsius (10° C.). Further, in FIG. 3, a line 48 denotes the brake torque loss of an intake manifold tuning valve at an intake air temperature of negative forty degrees Celsius (−40° C.). A line 50 denotes the brake torque loss of the intake manifold tuning valve at an intake air temperature of 0° C. A line 52 denotes the brake torque loss of the intake manifold tuning valve at an intake air temperature of 10° C. A line 54 denotes the brake torque loss of the intake manifold tuning valve at an intake air temperature of 40° C. And a line 56 denotes the brake torque loss of the intake manifold tuning valve at an intake air temperature of 50° C. Among the observations that can be made from the graph of FIG. 3, the line 56 of intake air temperature at 50° C. demonstrates the largest brake torque loss of nearly −5% at an approximate engine speed of 6,000 RPMs, and the line 48 of intake air temperature at −40° C. demonstrates a brake torque loss plateauing below −3% around an engine speed ranging between 5,800-6,000 RPMs. Skilled artisans will appreciate that similar demonstrations of brake torque losses like that of FIG. 3 can yield varying results.

The method of controlling the IMTV(s) 14 in the internal combustion engine 10 as detailed in this description aims to minimize or altogether eliminate the brake torque losses of past efforts. In the method, the temperature of air in the variable intake manifold 12 is a determinant in calibrating and/or setting the predetermined operating mode switching points of the IMTV(s) 14. Determining the predetermined operating mode switching points, as described herein, refers to determining subsequent perturbations upon the initial predetermined operating mode switching point; the initial predetermined operating mode switching point involves a calibration procedure. The method can have various steps in various embodiments dictated by—among other possible influences—the design and construction of the internal combustion engine in which the method is implemented. With reference again to FIGS. 1 and 2, a temperature sensor 58 transmits temperature measurement readings of air in the variable intake manifold 12 to a controller 60. The temperature sensor 58 can have difference placements at the internal combustion engine 10, and can take temperature measurements of the air residing upstream of the throttle bodies 28, 30, downstream of the throttle bodies 28, 30, or at the throttle bodies 28, 30. The controller 60 manages and instructs the opening and closing movement initiations of the IMTV(s) 14, and can be an engine control module of the internal combustion engine 10, a dedicated control module, or another control module of the larger application.

Incorporating the temperature of intake air as a factor for establishing the predetermined operating mode switching points of the IMTV(s) 14 can be effected in various ways in different embodiments. In one embodiment, an intake air correction factor is employed in setting the predetermined operating mode switching points. This embodiment is derived from a theory based on a ratio of speeds of sound. As the speed of sound changes with temperature variation, it is thought, so too the intake air wave dynamics or resonances change with temperature variation. This embodiment provides an estimation of the shifting of the predetermined operating mode switching points to different speeds of the internal combustion engine 10 at different temperatures of air in the variable intake manifold 12. The estimation begins with the speed of sound equation c=\sqrt{γRT}, where c is the speed of sound in air, γ is the specific heat ratio, R is the molecular gas constant, and T is temperature. The operating mode switching points of the IMTV(s), or tuning RPM points, are proportional to the speed of sound, and hence substitution alters the equation to Tuning RPM Point∝\sqrt{γRT}. An RPM ratio can be roughly equated to a ratio of speed of sounds, resulting in the equation

$$\frac{R P {M}_{2}}{R P {M}_{ref}} = k \frac{\sqrt{γ R {T}_{2}}}{\sqrt{γ R {T}_{ref}}} ,$$

where RPM₂ is the new engine speed of the shifted predetermined operating mode switching point, RPM_{ref} is the engine speed at which the base IMTV calibration was determined, T₂ is the temperature of intake air at which the IMTV calibration is intended to shift, T_{ref} is the temperature of intake air at which the base IMTV calibration was determined, and k is the intake air correction factor. The intake air correction factor k is meant to account for any unknowns present in the true system. That is, where the equation does not estimate the precise slope of the operating mode shifting points, k is the intake air correction factor. Furthermore, the equation can be refined to

$$\frac{R P {M}_{2}}{R P {M}_{ref}} = k \sqrt{\frac{{T}_{2}}{{T}_{ref}}} .$$

The graph of FIG. 4 presents a comparison between i) the estimation of the shifting of the predetermined operating mode switching points to different speeds at different intake air temperatures per the above equation but absent the intake air correction factor k (broken line 62), and ii) the actual shifting of the predetermined operating mode switching points to different speeds at different intake air temperatures per the above equation with the intake air correction factor k (solid line 64). In FIG. 4, engine speed in RPM is plotted on an x-axis 66, and ambient temperature of intake air in ° C. is plotted on a y-axis 68. Points 70 represent IMTV closing movement initiations in the graph. Among the observations that can be made from the graph of FIG. 4, the estimation line 62 proximately tracks the calibration line 64. Hence, this embodiment of the method employing the intake air correction factor may be suitable in applications in which a more involved calibration procedure is undesired that would call for additional lookup tables of IMTV position versus engine speed; by use of this relatively simple equation and a correction factor, only a single lookup table of IMTV position versus engine speed is called for. Skilled artisans will appreciate that similar comparisons like that of FIG. 4 can yield varying results.

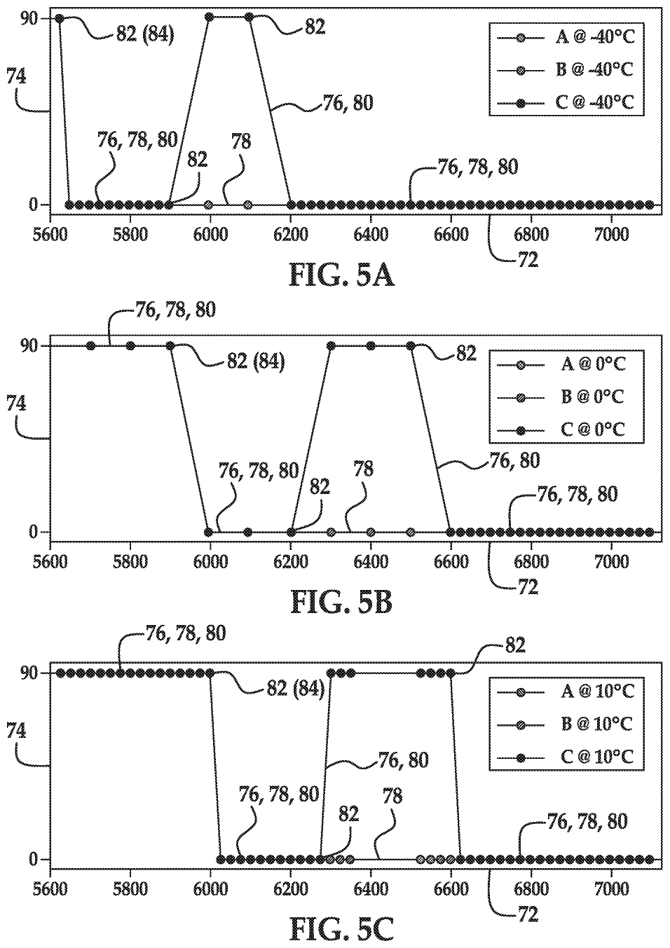

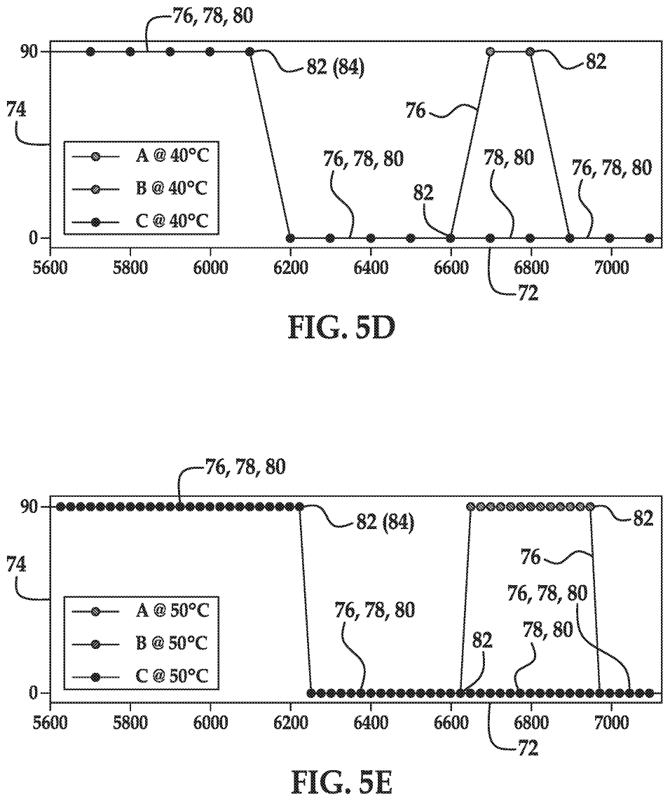

In another embodiment of incorporating the temperature of intake air as a factor for establishing the predetermined operating mode switching points of the IMTV(s) 14 employs the use of a lookup table. The controller 60 references the lookup table for instructing the opening and closing initiations of the IMTV(s) 14. In this embodiment, the lookup table is established by calibration procedures performed on a dynamometer. The resulting predetermined operating mode switching points are considered an optimized IMTV calibration as they are established based on intake air temperature. FIGS. 5A-5E present examples of optimal IMTV calibrations in graph form and exhibit the predetermined operating mode switching points shifting to increased engine speeds with increased intake air temperatures, and show previously-uninitiated operating mode switching points. In FIGS. 5A-5E, engine speed in RPM is plotted on an x-axis 72, and angle of intake manifold tuning valves in degrees) (°) is plotted on a y-axis 74. The engine speed values along the x-axis 72 can be considered a range of higher engine speeds. On the y-axis 74, at zero degrees) (0°) the IMTVs are in a closed state, and at ninety degrees) (90°) the IMTVs are in an open state.

The graphs of FIGS. 5A-5E present the optimal IMTV calibrations for three intake manifold tuning valves: a first intake manifold tuning valve 76 (labeled A), a second intake manifold tuning valve 78 (labeled B), and a third intake manifold tuning valve 80 (labeled C) (in the graphs the lines for the intake manifold tuning valves 76, 78, 80 overlap and trace one another over certain engine speeds). Furthermore, the graphs of FIGS. 5A-5E represent optimal IMTV calibrations at different intake air temperatures—FIG. 5A represents an intake air temperature of negative forty degrees Celsius (−40° C.), FIG. 5B represents intake air temperature of zero degrees Celsius (0° C.), FIG. 5C represents intake air temperature of ten degrees Celsius (10° C.), FIG. 5D represents intake air temperature of forty degrees Celsius (40° C.), and FIG. 5E represents intake air temperature of fifty degrees Celsius (50° C.). In other examples, these IMTV calibrations could be taken over various ranges of intake air temperatures and at various intervals of intake air temperatures (e.g., every 5° C.). Among the observations that can be made from the graphs of FIGS. 5A-5E, predetermined operating mode switching points (denoted by numeral 82) tend to shift to increased engine speeds with increased intake air temperatures—this is evident from observing a predetermined operating mode switching point 84 as it moves to higher engine speeds (i.e., rightward in the graphs) from FIG. 5A and to FIG. 5E. Furthermore, FIGS. 5D and 5E depict predetermined operating mode switching points 82 for the first intake manifold tuning valve 76 that are altogether lacking in the graphs of FIGS. 5A-5C and their accompanying intake air temperatures. Skilled artisans with appreciate that similar optimal IMTV calibrations like those of FIGS. 5A-5E can yield varying results.

Still, the method of controlling the IMTV(s) 14 in the internal combustion engine 10 with temperature of intake air as a factor for its control scheme can have other embodiments than those described and illustrated herein. For instance, as but one example, incorporating the temperature of intake air as a factor for establishing the predetermined operating mode switching points of the IMTV(s) 14 could involve taking measurement readings in more than one location, such as at the throttle bodies 28, 30 and also downstream of the throttle bodies 28, 30 at a location of the variable intake manifold 12 opposite the location of the throttle bodies 28, 30. In this example, the method of controlling the IMTV(s) 14 could account for temperature variations of intake air that might occur between these two locations as the intake air travels therebetween.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of controlling at least one intake manifold tuning valve in an internal combustion engine, the method comprising:
determining an operating mode switching point of the at least one intake manifold tuning valve based at least in part upon temperature of intake air in the intake manifold.

2. The method of controlling at least one intake manifold tuning valve in an internal combustion engine as set forth in claim 1, wherein the operating mode switching point of the at least one intake manifold tuning valve shifts to varying engine speeds at varying intake air temperatures.

3. The method of controlling at least one intake manifold tuning valve in an internal combustion engine as set forth in claim 1, wherein the at least one intake manifold tuning valve has a first operating mode switching point amid a range of higher engine speeds at a first intake air temperature, and the at least one intake manifold tuning valve has a second operating mode switching point amid the range of higher engine speeds at a second intake air temperature.

4. The method of controlling at least one intake manifold tuning valve in an internal combustion engine as set forth in claim 3, wherein the first operating mode switching point is initiated at a first engine speed of the range of higher engine speeds, and the second operating mode switching point is initiated at a second engine speed of the range of higher engine speeds.

5. The method of controlling at least one intake manifold tuning valve in an internal combustion engine as set forth in claim 1, wherein determining the operating mode switching point of the at least one intake manifold tuning valve involves the use of an intake air correction factor.

6. The method of controlling at least one intake manifold tuning valve in an internal combustion engine as set forth in claim 1, wherein determining the operating mode switching point of the at least one intake manifold tuning valve involves the use of an intake air temperature lookup table.

7. An internal combustion engine employing the method of controlling at least one intake manifold tuning valve as set forth in claim 1.

8. An internal combustion engine, comprising:
a variable intake manifold having at least one intake manifold tuning valve residing within a plenum of the variable intake manifold, the at least one intake manifold tuning valve being controlled by a controller and having a predetermined operating mode switching point that shifts to varying speeds of the internal combustion engine according to temperature of air in the variable intake manifold.

9. The internal combustion engine as set forth in claim 8, wherein the at least one intake manifold tuning valve has a first predetermined operating mode switching point amid a range of higher engine speeds at a first temperature of air in the variable intake manifold, and the at least one intake manifold tuning valve has a second predetermined operating mode switching point amid the range of higher engine speeds at a second temperature of air in the variable intake manifold.

10. The internal combustion engine as set forth in claim 9, wherein the first predetermined operating mode switching point is initiated at a first engine speed of the range of higher engine speeds and the second predetermined operating mode switching point is initiated at a second engine speed of the range of higher engine speeds.

11. The internal combustion engine as set forth in claim 8, wherein control of the at least one intake manifold tuning valve via the controller at the predetermined operating mode switching point involves the use of intake air correction factor.

12. The internal combustion engine as set forth in claim 8, wherein control of the at least one intake manifold tuning valve via the controller at the predetermined operating mode switching point involves the use of a lookup table.

13. A method of controlling at least one intake manifold tuning valve in an internal combustion engine, the method comprising:
initiating opening and closing movements of the at least one intake manifold tuning valve according to temperature of intake air in the intake manifold, wherein the initiated opening and closing movements of the at least one intake manifold tuning valve shifts to varying engine speeds at varying intake air temperatures.

14. The method of controlling at least one intake manifold tuning valve in an internal combustion engine as set forth in claim 13, wherein the initiated opening and closing movements of the at least one intake manifold tuning valve are per a predetermined operating mode switching point that shifts to varying engine speeds according to temperature of intake air in the intake manifold.

15. The method of controlling at least one intake manifold tuning valve in an internal combustion engine as set forth in claim 13, wherein the opening and closing movements of the at least one intake manifold tuning valve are initiated amid a range of higher engine speeds at a first temperature of intake air in the intake manifold, and the opening and closing movements of the at least one intake manifold tuning valve are initiated amid a range of higher engine speeds at a second temperature of intake air in the intake manifold.

16. The method of controlling at least one intake manifold tuning valve in an internal combustion engine as set forth in claim 15, wherein initiating opening and closing movements of the at least one intake manifold tuning valve according to temperature of intake air in the intake manifold involves the use of an intake air correction factor.

17. The method of controlling at least one intake manifold tuning valve in an internal combustion engine as set forth in claim 15, wherein initiating opening and closing movements of the at least one intake manifold tuning valve according to temperature of intake air in the intake manifold involves the use of an intake air temperature lookup table.

18. An internal combustion engine employing the method of controlling at least one intake manifold tuning valve as set forth in claim 13.
